(19) United States
(12) Patent Application Publication
(10) Pub. No.: US 2006/0043883 A1
(43) Pub. Date: Mar. 2, 2006

(54) Plasma display panel

(76) Inventors: Chong-Gi Hong, Suwon-si (KR); Kyoung-Doo Kang, Suwon-si (KR); Tae-Kyoung Kang, Suwon-si (KR)

Correspondence Address: MCGUIREWOODS, LLP, 1750 TYSONS BLVD, SUITE 1800, MCLEAN, VA, 22102, US

(21) Appl. No.: 11/145,934

(22) Filed: Jun. 7, 2005

(30) Foreign Application Priority Data
Aug. 28, 2004 (KR) 10-2004-0068310

(51) Int. Cl. H01J 1/62

(52) U.S. Cl. 313/505

(57) ABSTRACT

A plasma display panel (PDP) is provided capable of improving luminous efficiency by enlarging a discharge space, and lowering a discharge firing voltage. The plasma display panel includes a first dielectric layer next to a discharge cell in which a plurality of grooves are formed such that each groove is formed between an X electrode and a Y electrode of the discharge cell and covering the sustain electrode pairs and the intermediate electrodes.

### CROSS-REFERENCE TO RELATED PATENT APPLICATIONS

This application claims priority to and the benefit of Korean Patent Application No. 10-2004-0068310, filed on Aug. 28, 2004, in the Korean Intellectual Property Office, the disclosure of which is incorporated by reference for all purposes as if fully set forth herein.

### BACKGROUND OF THE INVENTION

1. Field of the Invention

The present invention relates to a plasma display panel (PDP), and more particularly, to a PDP having improved luminous efficiency, low discharge firing voltage, and improved brightness uniformity.

2. Description of the Related Art

A plasma display panel (PDP), which may function as a replacement for a conventional cathode-ray tube display, is an apparatus in which discharge gas is filled between two substrates having a plurality of electrodes on each substrate. A discharge voltage is applied to the electrodes, and phosphors arranged on the substrate with a predetermined pattern are excited by ultraviolet light generated by the discharge gas to luminesce upon de-excitation (i.e.: the phosphor atoms emit light when transitioning from an excited state to the ground state) thereby forming a desired image.

FIG. 1 illustrates a conventional AC plasma display panel 10, which includes an upper plate 50 and a lower plate 60, where the lower plate 60 is positioned parallel with the upper plate 50. Sustain electrode pairs 12, each having an X electrode 31 and a Y electrode 32, are arranged on a front substrate 11 of the upper plate 50. Address electrodes 22 are arranged on an upper surface of a rear substrate 21 facing the front substrate 11 to orthogonally overlap the electrodes 31 and 32 of the front substrate 11. A portion of a discharge space defined by an intersection of a sustain electrode pair 12 and an address electrode 22 corresponds to a unit discharge cell 70. A first dielectric layer 15 and a second dielectric layer 25 are respectively formed on a surface of the front substrate 11 and on a surface of the rear substrate 21, to cover the sustain electrode pairs 12 and the address electrodes 22.

A protection layer 16, which is made of an insulator such as, for example, MgO, is formed on a surface of the first dielectric layer 15. Barrier ribs 30 are formed on a surface of the second dielectric layer 25 to maintain a discharge distance and to prevent electrical and optical cross-talk between adjacent discharge cells 70. A phosphor layer 26, such as a red-emitting phosphor, a green-emitting phosphor or a blue-emitting phosphor layer, is formed to cover the lateral sides of the barrier ribs 30 and the exposed surfaces of the second dielectric layer 25. Each X electrode 31 includes a transparent electrode 31a and a bus electrode 31b. Each Y electrode 32 also includes a transparent electrode 32a and a bus electrode 32b.

To enlarge a discharge space in the plasma display panel 10, a distance between the X electrode 31 and Y electrode 32 should be increased. This is because as the distance between the X electrode 31 and Y electrode 32 is increased, a larger discharge occurs in a larger space. However, as the distance between the X electrode 31 and Y electrode 32 is increased, a higher discharge firing voltage is required, resulting in increased power consumption.

### SUMMARY OF THE INVENTION

The present invention provides a PDP capable of improving luminous efficiency by enlarging a discharge space while allowing a low discharge firing voltage.

The present invention also provides a PDP capable of improving uniformity in brightness in discharge cells.

Additional features of the invention will be set forth in the description which follows, and in part will be apparent from the description, or may be learned by practice of the invention.

The present invention discloses a plasma display panel having a rear substrate and a front substrate separated from the rear substrate. The plasma display panel also includes barrier ribs disposed between the front substrate and the rear substrate and defining discharge cells, and sustain electrode pairs comprising an X electrode and a Y electrode and overlapping the discharge cells. The plasma display panel further includes an intermediate electrode arranged between an X electrode and Y electrode of each sustain electrode pair, and a first dielectric layer comprising grooves which are formed such that each groove is located between an X electrode and a Y electrode of each sustain electrode pair and covering the sustain electrode pairs and corresponding to the intermediate electrode. The plasma display panel additionally includes address electrodes extending across the discharge cells and overlapping the sustain electrode pairs and the intermediate electrodes, and a second dielectric layer covering the address electrodes. The plasma display panel also includes phosphor layers respectively formed in the discharge cells, and discharge gas filling the discharge cells.

The present invention also discloses a discharge cell of a plasma display device having a first dielectric layer arranged on a substrate, wherein a surface of the first dielectric layer defines a groove in the first dielectric.

The present invention also discloses an upper plate of plasma display device having a front substrate and a first dielectric arranged on the front substrate, wherein the first dielectric comprises thinner regions and thicker regions arranged in a predetermined pattern.

It is to be understood that both the foregoing general description and the following detailed description are exemplary and explanatory and are intended to provide further explanation of the invention as claimed.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIG. 1 illustrates a conventional plasma display panel.

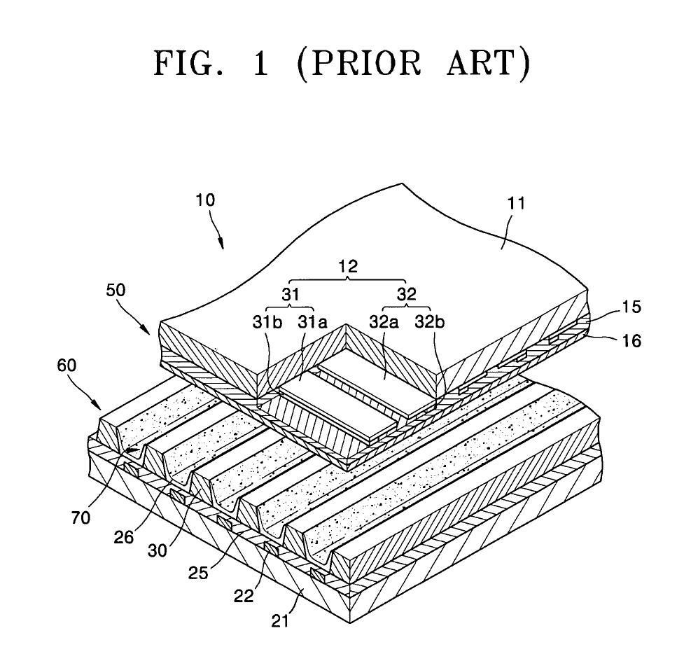

FIG. 2 illustrates a plasma display panel according to an embodiment of the present invention.

FIG. 3 illustrates a cross-sectional view along a line III-III of FIG. 2, showing the upper plate shown in FIG. 2 rotated by 90°, according to an embodiment of the present invention.

FIG. 4 illustrates the upper plate shown in FIG. 2, according to another embodiment of the present invention.

FIG. 5 is a block diagram of a plasma display apparatus.

FIG. 6 is a timing diagram of signals applied to electrodes for a discharge cell in a unit sub-field of the plasma display panel of FIG. 2.

FIG. 7 shows an exemplary brightness distribution in a discharge cell in a sustain-discharge time S of FIG. 6.

FIG. 8 is a graph illustrating brightness deviation according to a relative ratio H/D of the depth D of a groove with respect to the depth D of a first dielectric layer.

FIG. 9 is a graph illustrating a sustain-discharge voltage according to the relative ratio H/D of the depth H of the groove with respect to the depth D of the first dielectric layer.

### DETAILED DESCRIPTION OF THE ILLUSTRATED EMBODIMENTS

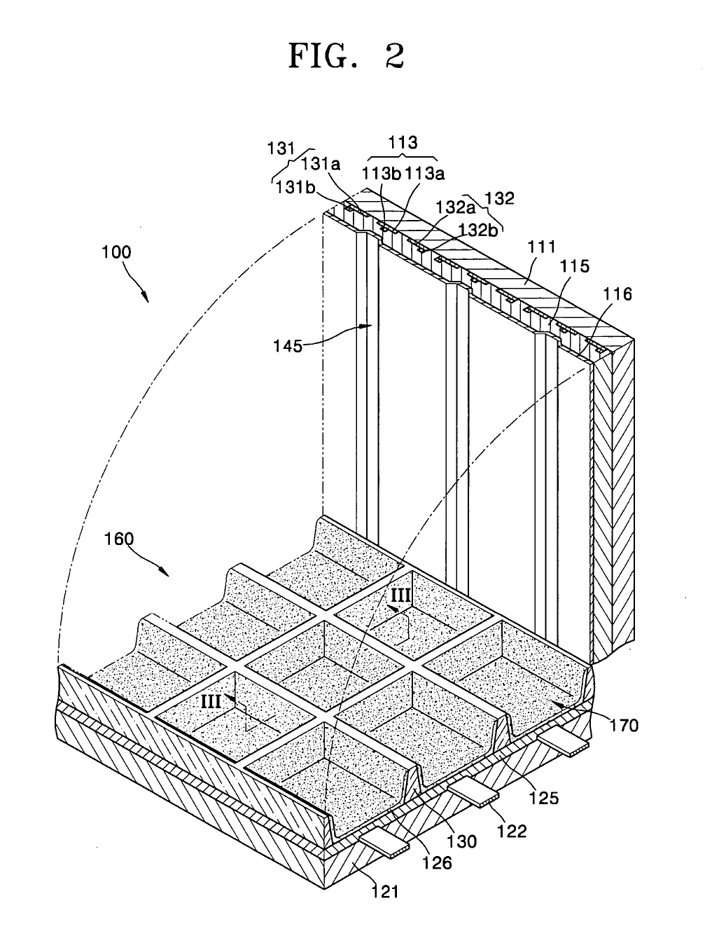

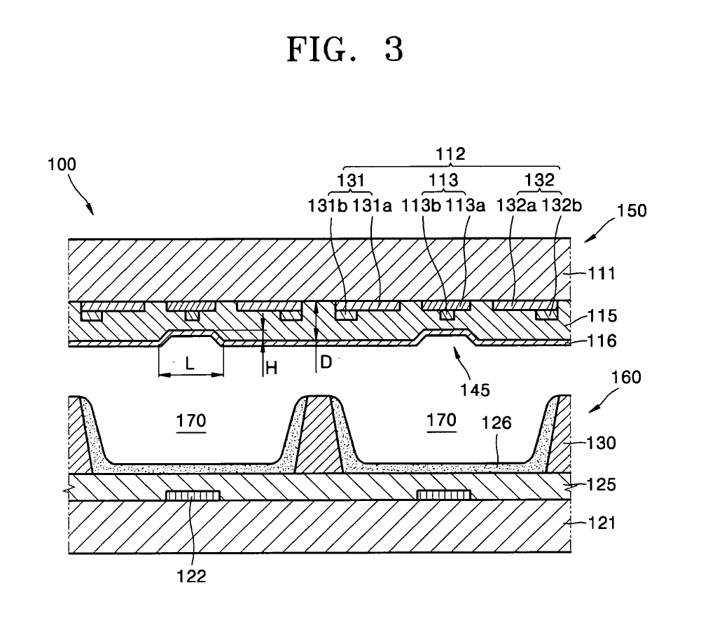

An AC plasma display panel 100 according to an embodiment of the present invention is described with reference to FIG. 2 and FIG. 3, where FIG. 3 illustrates an upper plate 150 of the plasma display panel 100 rotated by 90°, and FIG. 3 illustrates the plasma display panel 100 including an upper plate 150 and a lower plate 160 fixed parallel to one another.

Referring to FIG. 2 and FIG. 3, a plurality of discharge cells 170 are partitioned by barrier ribs 130 between a front substrate 111 disposed on the upper plate 150 and a rear substrate 121 disposed on the lower plate 160. The barrier ribs 130 reduce or prevent electrical and optical cross-talk between the discharge cells 170, and also partition the discharge cells 170 into rectangular sections. The barrier ribs 130 can be formed in various patterns, such as, for example, an open pattern such as a stripe pattern, or a closed pattern, such as a waffle pattern, a matrix pattern, or a delta pattern. Also, a cross-section of each discharge cell partitioned by barrier ribs 130 may be formed in a closed pattern in various shapes, such as, for example, a triangle, a square, a pentagon, a circle, an ellipse, etc.

A plurality of sustain electrode pairs 112 are arranged on the front substrate 111. The front substrate 111 may be made of a transparent material such as glass. A sustain electrode pair 112 may include a pair of sustain electrodes 131 and 132 formed on the rear surface of the front substrate 111 to generate and sustain a discharge. Such sustain electrode pairs 112 are arranged in parallel and spaced a predetermined distance on the front substrate 111. Each of the sustain electrode pairs 112 includes an X electrode 131 and a Y electrode 132. In this embodiment, the sustain electrode pairs 112 are disposed on the rear surface of the front substrate 111, however, the present invention is not limited to this configuration and the sustain electrode pairs 112 may disposed in other positions. For example, the sustain electrode pairs 112 can be disposed with a predetermined spacing from the rear surface of the front substrate 111. Preferably, the X electrode 131 and the Y electrode 132 of the sustain electrode pairs 112 are located at the same height from the front substrate 111.

Each X electrode 131 includes a transparent electrode 131a and a bus electrode 131b, and each Y electrode 132 includes a transparent electrode 132a and a bus electrode 132b. The transparent electrodes 131a and 132a are made of transparent material, such as, for example, ITO (Indium Tin Oxide), having a conductivity allowing an electrical discharge as well as transmitting light emitted from phosphors 126 to the front substrate 111. However, since transparent conductive materials, such as ITO, generally have higher resistance, transparent electrode 131a and transparent electrode 131b have a relatively high voltage drop in their longitudinal directions, which requires higher driving power and reduces a response speed.

To solve these problems, narrower bus electrode 131b and bus electrode 132b are made of metal material and are provided on transparent electrode 131a and transparent electrode 132a to reduce electrical resistance. Bus electrode 131b and bus electrode 132b may be formed in a single-layer structure using a metal such as Ag, Al, or Cu. Alternatively, bus electrode 113b and bus electrode 132b may be formed in a multi-layer structure such as Cr/Al/Cr. The transparent electrode 131a and transparent electrode 132a and bus electrode 131b and bus electrode 132b may be formed using a photoetching process and a photolithography process, etc.

Intermediate electrodes 113 may be respectively disposed between the pairs of the X electrodes 131 and the Y electrodes 132, such that each intermediate electrode 113 is disposed between a pair of an X electrode 131 and a Y electrode 132. The intermediate electrodes 113 may be formed on the rear surface of the front substrate 111 and may extend parallel to the X electrodes 131 and Y electrodes 132 across the discharge cells 170. Also, the intermediate electrode 113 may be formed spaced by about the same distance from the corresponding X electrode 131 and the Y electrode 132.

The intermediate electrode 113 includes a transparent electrode 113a and a bus electrode 113b. The intermediate electrode 113 may be disposed at a different height compared to the X electrode 131 and Y electrode 132. However, preferably, the intermediate electrode 113 is disposed at the same height as the X electrode 131 and the Y electrode 132 to allow forming all the electrodes at once through a single electrode forming process.

After electrode formation, a first dielectric layer 115 covers the sustain electrode pairs 112 and the intermediate electrodes 113. The first dielectric layer 115 may be made of dielectric material capable of preventing direct electrical conduction between the adjacent X electrode 131 and Y electrode 132 and the intermediate electrode 113 during discharge. Accordingly, the first dielectric layer 115 may reduce or prevent damage to the X electrode 131, Y electrode 132, and intermediate electrode 113 due to the collision of charged particles (positive ions or electrons) with the X electrode 131, Y electrode 132, and intermediate electrode 113, and allows the charged particles to be accumulated as wall charges. Such dielectric material may include PbO, B₂O₃, SiO₂, and the like.

After the first dielectric layer 115 is formed, grooves 145 are respectively formed in the first dielectric layer 115 between the pairs of the X electrodes 131 and Y electrodes 132. Each groove 145 is formed with a predetermined depth in the first electric layer 115. The first dielectric layer 115 is configured so that visible light has a higher transmittance in a forward direction through the thinner portions of the first dielectric layer 115 formed by the grooves 145.

Also, in the present embodiment, the groove 145 has a cross-section defining a trapezoid, however, the groove 145 can be formed in various forms or shapes. Additionally, the grooves 145 can be formed by various processes. For example, the grooves 145 can be formed through a sandblasting process on the first dielectric layer 115. Also, the grooves 145 can be formed by exposing and developing after applying a photomask where the first dielectric layer 115 is made of a photosensitive dielectric. “H” represents the depth of the groove 145 and “D” represents a thickness of the first dielectric layer 115 in a region next to the groove 145.

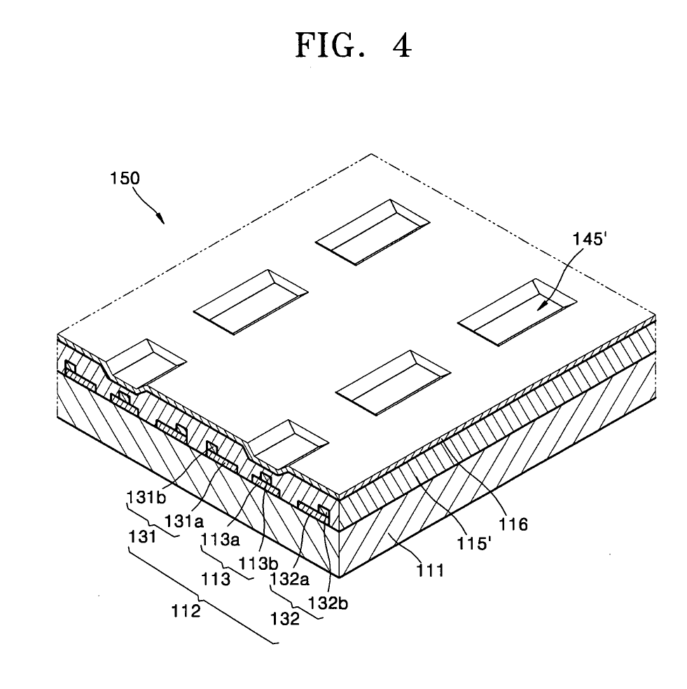

Referring to FIG. 2, each groove 145 is formed between an X electrode 131 and Y electrode 132 pair and extends in a direction parallel to the X electrode 131 and Y electrode 132. In this configuration, the groove 145 can provide an exhaust path through which impure gas in a discharge space is exhausted, and also provide an inflow path through which discharge gas flows into the discharge space in a filling process. However, as shown in FIG. 4, grooves 145′ can be discontinuously formed in a first dielectric layer 115′ across the respective discharge cells. Here, the grooves 145′ can also be formed in various shapes. A volume of the discharge space defined by an intersecting X electrode 131, Y electrode 132, intermediate electrode 113, and an address electrode 122 which corresponds to a unit discharge cell.

Referring again to FIG. 3, a stronger electric field may be generated in the groove 145, which may increase the density of electrons and ions because a discharge path between the X electrode 131 and the Y electrode 132 is shorter. Accordingly, a stronger plasma discharge may occur in each groove 145. Particularly, as the depth H of the groove 145 becomes deeper, a discharge between the X electrode 131 and Y electrode 132 becomes similar to an opposed discharge.

In this embodiment, a relative depth to thickness ratio H/D of the depth H of the groove 145 with respect to the thickness D of the first dielectric layer 115 may be from about 0.15 through about 0.45. Additionally, in some embodiments, the depth H of the groove 145 may be from about 6 μm through about 18 μm. Also, to more uniformly generate a discharge in the discharge cells 170, the grooves 145 may be positioned symmetrically with respect to the discharge cells 170. The groove 145 may also be formed in a portion of the first dielectric layer 115 covering the intermediate electrode 113. The relationship between the depth H of the groove 145 and the thickness D of the first dielectric layer 115 is described below.

A protection layer 116 is formed on the first dielectric layer 115. The protection layer 116 reduces or prevents direct collisions of positive ions and electrons with the first dielectric layer 115 during discharge to avoid damage to the first dielectric layer 115. Also, the protection layer 116 may discharge a large amount of secondary electrons during discharge, thus facilitating plasma discharge. Accordingly, the protection layer 116 is made of material with a high discharge coefficient for secondary electrons and with high transmittance for visible light.

The protection layer 116 may include, for example, a thin film of MgO formed on the first dielectric layer 115. The protection layer 116 is generally formed by sputtering or electron beam deposition after other fabrication processes are completed on the upper plate 150.

Address electrodes 122 are arranged on the front surface of the rear substrate 121 in a direction orthogonally intersecting the X electrodes 131, the Y electrodes 132, and the intermediate electrodes 113. The address electrodes 122 may generate an address discharge to facilitate a sustain-discharge between the X electrodes 131 and the Y electrodes 132. Specifically, the address electrodes 122 contribute to lower a voltage for generating a sustain-discharge. In this embodiment, an address-discharge may be generated between the intermediate electrodes 113 and the address electrodes 122.

A second dielectric layer 125 may be formed on the upper surface of the rear substrate 121 to cover the address electrodes 122. The second dielectric layer 125 may be made of dielectric material capable of preventing the direct collision of positive ions and electrons with the address electrodes 122. Accordingly, the second dielectric layer 125 may reduce or prevent damage to the address electrodes 122 and may further attract charges. The second dielectric layer 125 may be made of a dielectric material, such as, for example, PbO, B₂O₃, SiO₂, and the like.

A phosphor layer 126, such as a red-emitting, a green-emitting, or a blue-emitting phosphor layer is formed to cover the exposed surfaces of the second dielectric layer 125 and the lateral portions or sidewalls of the barrier ribs 130.

The phosphor layers 126 are capable of receiving ultraviolet light and generating visible light. For example, the red-emitting phosphor layers may include a material such as, for example, Y(V,P)O₄:Eu, the green-emitting phosphor layers may include a material such as, for example, Zn₂SiO₄:Mn, and the blue-emitting phosphor layers may include a material such as BAM:Eu.

Also, discharge cells 170 may be filled with a discharge gas such as Ne, Xe, etc. After the discharge gas is filled into the discharge cells 170, the front substrate 111 and rear substrate 121 are coupled and sealed to each other by a sealing material such as frit glass provided along the edges of the substrates 111 and 121.

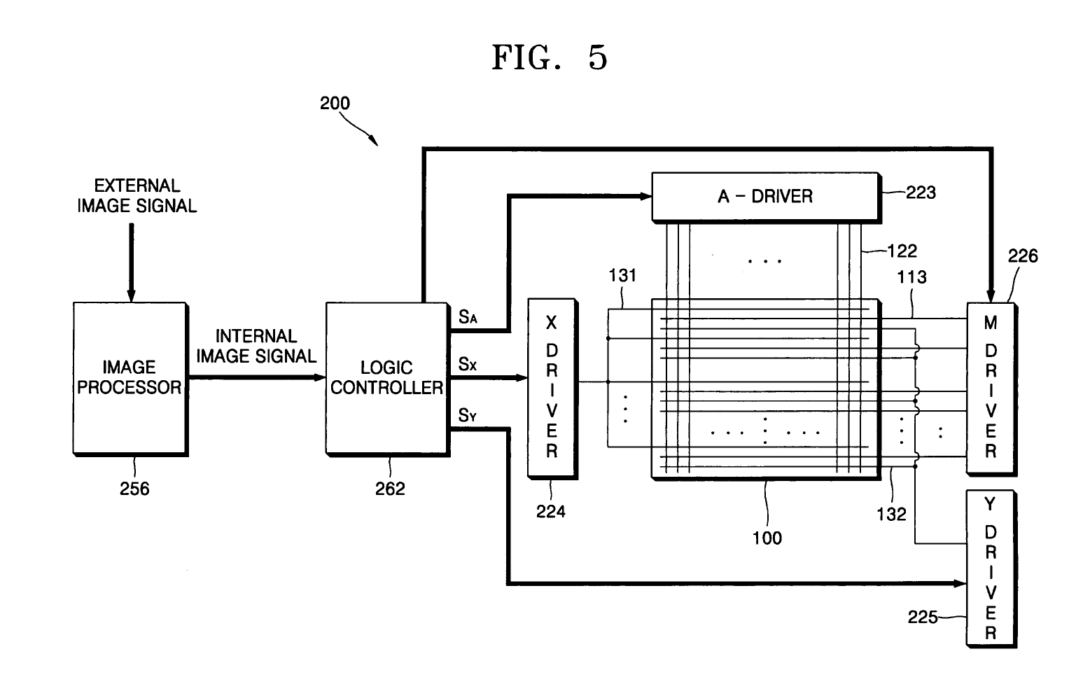

Referring to FIG. 5, a plasma display apparatus 200 is shown including a plasma display panel 100 according to an embodiment of the present invention. The plasma display apparatus 200 includes an image processor 256, a logic controller 262, an A driver 223 (i.e., address driver), an X driver 224, a Y driver 225, and a M driver 226. X electrodes 131, Y electrodes 132, and intermediate electrodes 113 are shown as a plurality of lines.

The Y electrodes 132 extend in a first direction along the front substrate 111 and are interconnected at one end. When the plasma display panel 100 is driven by a signal, the same electrical signal is applied to all the Y electrodes 132, and the Y electrodes 132 are accordingly electrically interconnected to one another in common.

Likewise, a same electrical signal is applied to the X electrodes 131, and the X electrodes 131 are also electrically interconnected to one another in common. However, independent signals are applied to the intermediate electrodes 113, and the intermediate electrodes 113 must be separately connected to input lines to the M driver 226 without interconnection to each other.

The arrangement and form of the intermediate electrode 113, address electrode 122, X electrode 131, and Y electrode 132 shown in FIG. 5 of the plasma display panel 100 of each unit discharge cell 170 are similar to those of the intermediate electrode 113, address electrode 122, X electrode 131, and Y electrode 132 shown in FIGS. 2 and 3.

In operation of the plasma display apparatus, the image processor 256 converts an external analog signal into a digital signal and generates an internal image signal. The internal image signal may include, for example, R/G/B image data, a clock signal, or horizontal and vertical synchronization signals, each having 8 bits. The logic controller 262 generates driving control signals S_{A}, S_{X}, S_{Y}, and S_{M} in response to the internal image signal received from the image processor 256.

Signal S_{A} is a driving signal applied to the address electrodes 122, signal S_{X} is a driving signal applied to the X electrodes 131, signal S_{Y} is a driving signal applied to the Y electrodes 132, and signal S_{M} is a driving signal applied to the intermediate electrodes 113.

The A driver 223 processes the address driving signal S_{A} from among the driving control signals S_{A}, S_{X}, S_{Y}, and S_{M} received from the logic controller 262 to generate a display data signal, and applies the resulting display data signal to the address electrodes 122. The X driver 224 processes the X driving control signal S_{X} from among the driving control signals S_{A}, S_{X}, S_{Y}, and S_{M} received from the logic controller 262, and applies the resulting signal to the X electrodes 131. The Y driver 225 processes the Y driving control signal S_{Y} from among the driving control signals S_{A}, S_{X}, S_{Y}, and S_{M} received from the logic controller 262 and applies the resulting signal to the Y electrodes 132. The M driver 226 processes the M driving control signal S_{M} from among the driving control signals S_{A}, S_{X}, S_{Y}, and S_{M} received from the logic controller 262 and applies the resulting signal to the intermediate electrodes 113.

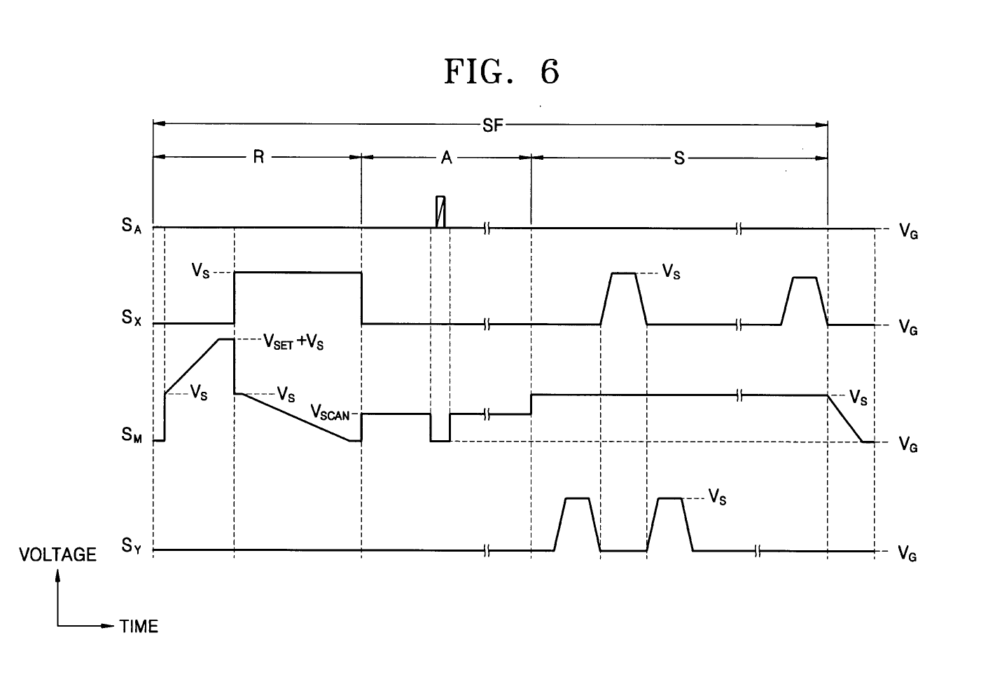

FIG. 6 is a timing diagram showing a unit time frame for signals applied to the intermediate electrode 113, address electrode 122, X electrode 131, and Y electrode 132 in a unit sub-field SF of the plasma display panel 100. The unit time frame can be divided into 8 sub-fields to create a time division type gray-scale display. Accordingly, a sub-field may be divided into a reset period R, an address period A, and a sustain-discharge period S.

In general, during the reset period R, a rising ramp voltage pulse is first applied to the intermediate electrodes 113, thus generating a discharge. Next, a falling ramp voltage pulse is applied to the intermediate electrodes 113, thus generating an erase discharge. The rising ramp voltage pulse and the falling ramp voltage pulse together are part of a reset discharge process which is generated throughout the plasma display panel 100 to uniformly distribute wall charges in the discharge cells 170. In more detail, the reset discharge process includes a ground voltage V_{G} which is applied as a first voltage to the address electrodes 122 and the Y electrodes 132. The rising ramp voltage pulse is applied to the intermediate electrodes 113 and rises from a voltage V_{S} to a second voltage V_{SET}+V_{S}, and, then, falls back to the first voltage V_{G}. At this time, the first voltage V_{G} is first applied to the X electrodes 131, and, then, a sustain voltage V_{S} is applied as a third voltage to the X electrodes 131 while the second voltage V_{SET}+V_{S} is being applied to the intermediate electrodes 113 to decrease to the first voltage V_{G}.

During the address time A, display data pulses of an address voltage V_{A} are applied to the address electrodes 122, and, simultaneously, a scanning pulse of the first voltage V_{G} is applied to the intermediate electrodes 113 biased to a scanning voltage V_{SCAN} which is lower than the third voltage V_{S}. Accordingly, if high-level display data pulses are applied while the scanning pulse is applied, wall charges are accumulated on the X electrodes 131, intermediate electrodes 113, and Y electrodes 132 by address discharge. However, since no display data pulse is applied to discharge cells not needing address discharge, no wall charge is formed in such discharge cells.

During the sustain-discharge period S, a sustain-discharge pulse is alternately applied to all the X electrodes 131 and all the Y electrodes 132, thus generating a sustain-discharge if wall charges have been formed during the corresponding address period A. The intermediate electrodes 131 and the address electrodes 122 are respectively biased to the third voltage V_{S} and the first voltage V_{G}.

However, during the sustain-discharge firing period, since the first voltage V_{G} is applied to the X electrodes 131 on which negative wall charges are accumulated, and the third voltage V_{S} is applied to the intermediate electrodes 113 on which positive wall charges are accumulated, discharge firings between the X electrodes 131 and intermediate electrodes 113 are relatively closely to one another. Accordingly, since discharge firings between the electrodes 113 and 131 are close, a discharge firing voltage is reduced. After a discharge is generated between the X electrodes 131 and the intermediate electrodes 113, the corresponding discharge area may be spread to the Y electrodes 132 and a sustain-discharge is generated between the X electrodes 131 and the Y electrodes 132.

At this time, the first voltage V_{G} and the third voltage V_{S} are alternately applied to the Y electrodes 132 and the X electrodes 131 so that a sustain-discharge which generates predetermined gray-scale luminous output levels during the sustain-discharge period is successively generated, thereby forming an image. Particularly, since a discharge between the X electrodes 131 and the Y electrodes 113 starts at a relatively low voltage, it is possible to increase the distance between the X electrode 131 and the Y electrode 132 thereby increasing the size of the discharge path. Accordingly, since the discharge path increases, a larger discharge is actively generated, which enhances luminous efficiency. As a result, due to the sustain-discharge between the X electrodes 131, intermediate electrodes 113, and Y electrodes 132, a minimum discharge firing voltage is reduced and luminous efficiency of the display device is increased. When the sustain-discharge is activated, an energy level of excited discharge gas is lowered so that ultraviolet light is emitted. The emitted ultraviolet light excites the phosphor layers 126 formed in the discharge cells 170, so that the energy level of the excited phosphor layers 126 is raised and then lowered to emit visible light. The visible light is transmitted through the first dielectric layer 115 and the front substrate 111, thus forming an image to be viewed by a user.

The brightness of the plasma display panel 100 is proportional to the length of a sustain-discharge period S included in a unit frame. In this embodiment, the total length of the sustain-discharge periods included in the unit frame is about 255T (where T is a predetermined unit of time). Each unit frame is divided into 8 sub-fields SF₁, SF₂, SF₃, SF₄, SF₅, SF₆, SF₇, and SF₈ in order to implement time division gray-scale display. Accordingly, a time 1T corresponding to 2⁰ is set to a sustain-discharge time of the first sub-field SF₁; a time 2T corresponding to 2¹ is set to a sustain-discharge time of the second sub-field SF₂; a time 4T corresponding to 2² is set to a sustain-discharge time of the third sub-field SF₃; a time 8T corresponding to 2³ is set to a sustain-discharge time of the fourth sub-field SF₄; a time 16T corresponding to 2⁴ is set to a sustain-discharge time of the fifth sub-field SF₅; a time 32T corresponding to 2⁵ is set to a sustain-discharge time of the sixth sub-field SF₆; a time 64T corresponding to 2⁶ is set to a sustain-discharge time of the seventh sub-field SF₇; and a time 128T corresponding to 2⁷ is set to a sustain-discharge time of the eighth sub-field SF₈. Accordingly, by appropriately selecting sub-fields to be displayed from among the 8 sub-fields, all 256 gray-scale levels including a gray-scale of 0 not appearing in the sub-field can be represented.

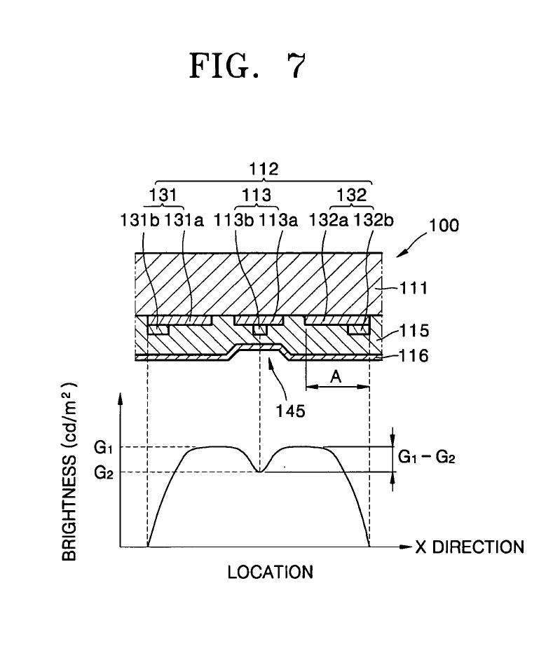

FIG. 7 illustrates an example of a brightness distribution graph which may be generated by the discharge cell 170 during the sustain-discharge period S of the plasma display panel 100. The brightness is measured along a horizontal or X direction in a cross-section taken perpendicular to a direction in which a sustain electrode pair 112 extends. The plasma discharge is strongest between an X electrode 131 and a Y electrode 132, and thus brightness is relatively high between the X electrode 131 and Y electrode 132. Also, since the arrangement of the intermediate electrode 113, X electrode 131, and Y electrode 132 have a symmetrical structure, the brightness distribution is substantially symmetrical with respect to the horizontal direction. However, since an intermediate electrode 113 is disposed between the X electrode 131 and the Y electrode 132, apparent brightness can be decreased due to reduction in transmittance in the layer adjacent to the intermediate electrode 113. Even though the transparent electrode 113a is made of ITO with relatively good transmittance, the transparent electrode 113a has relatively poor transmittance for visible light nonetheless and a reduction in apparent brightness results near the transparent electrode 113a. Additionally the bus electrode 113b has a relatively low transmittance for visible light which also reduces apparent brightness. Such brightness non-uniformity in a discharge cell 170 may cause deterioration in picture quality.

However, in the present invention, with a groove 145 formed in the portion of the first dielectric layer 115 creating a narrower portion of the first dielectric layer 115 covering the intermediate electrode 113 as described above, it is possible to compensate for a reduction in transmittance caused by the intermediate electrode 113. Therefore, at least one of the following two effects can be obtained: 1) a portion of the first dielectric layer 115 is narrower due to the groove 145, and transmittance is improved in the narrower portion; and, 2) plasma discharge is actively generated and brightness increases in the narrower portion of the first dielectric layer 115 because an electric field is enhanced in the narrower portion in which the groove 145 is formed, and a density of priming particles such as space charges is higher near the narrowed portion. In particular, as the depth H of the groove 145 becomes deeper, an opposed discharge effect may be obtained between the X electrode 131 and the Y electrode 132 which enhances plasma discharge activation. However, if the depth H of the groove 145 is too deep with respect to the thickness D of the first dielectric layer 115, the first dielectric layer 115 may be damaged during discharge. Accordingly, a certain ratio range between the thickness D of the first dielectric layer 115 and the depth H of the groove 145 is an important parameter for maintaining uniform brightness and preventing the damage of the first dielectric layer 115.

In some embodiments of the present invention, a brightness deviation of a discharge cell is measured with respect to a relative ratio H/D of the depth H of a groove in a first dielectric layer with respect to the depth D of the first dielectric layer as a dimensionless parameter. In this example, the widths A of the transparent electrode 113a, transparent electrode 131a, and transparent electrode 132a of the intermediate electrode 113, the X electrode 131, and the Y electrode 132 are about 120 μm, respectively, and the thickness D of the first dielectric layer 115 is about 40 μm. Also, a maximum width L of the groove 145 is about 130 μm.

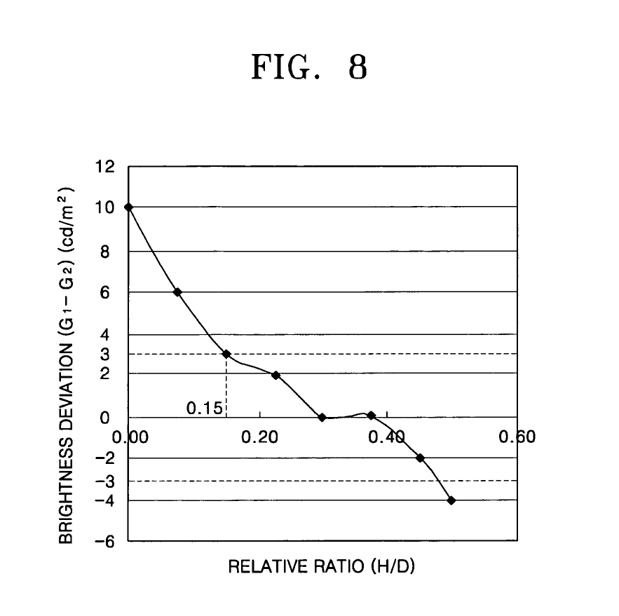

FIG. 8 shows a graph of test results of measured brightness deviation G₁-G₂ with respect to the depth H of the groove 145 ranging from 0 μm to about 20 μm where the thickness D of the first dielectric layer 115 is held constant. The brightness deviation G₁-G₂ is defined as a difference between a constant brightness (hereinafter, referred to as “first brightness value G₁”) between the intermediate electrode 113 and the X electrode 131 (or Y electrode 132), and a brightness (hereinafter, referred to as “second brightness value G₂”) in a central region of a discharge cell 170 including the intermediate electrode 113. If the brightness deviation G₁-G₂ has a positive value, the first brightness value G₁ is greater than the second brightness value G₂. Alternatively, if the brightness deviation G₀-G₂ has a negative value, the first brightness value G₁ is less than the second brightness value G₂.

In the case of a discharge cell with relatively uniform brightness, the absolute value |G₁-G₂| of brightness deviation G₀-G₂ should fall within a predetermined range, which is preferably below about 6 cd. Accordingly, the ratio of H/D may be configured so that the absolute value |G₁-G₂| is below about 6 cd. For example, referring again to FIG. 8, an absolute value |G₁-G₂| of brightness deviation is smaller than about 6 cd for a relative ratio H/D of about 0.15 to about 0.45. Accordingly, if the relative ratio H/D is 0 (i.e. no groove exists) the absolute value |G₁-G₂| of brightness deviation is large (about 10 cd). However, if the relative ratio H/D exceeds 0.45, the first dielectric layer 115 may be damaged during discharge. Therefore, in order to maintain a relatively uniform brightness of the discharge cell 170 and reduce the possibility of damage to the first dielectric layer 115, it is preferable to choose dimensions of the groove 145 so that the relative ratio H/D is between about 0.15 and about 0.45.

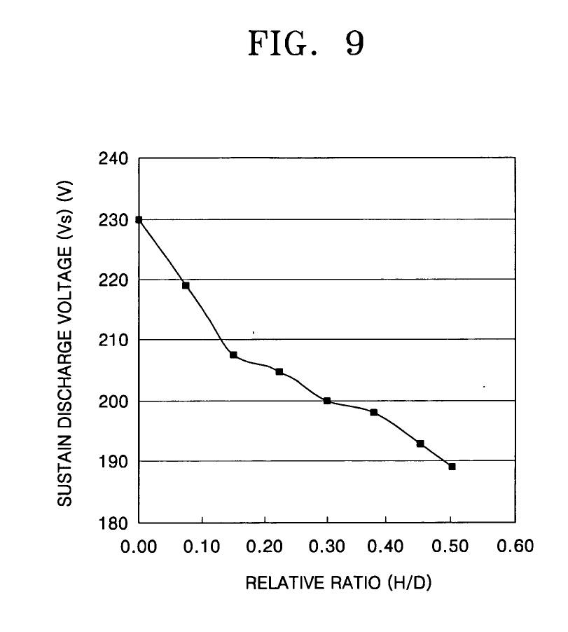

FIG. 9 is a graph illustrating a sustain-discharge voltage V_{S} versus relative ratio H/D. As FIG. 9 shows, as the relative ratio H/D increases, the sustain discharge voltage V_{S} decreases. Additionally, if the relative ratio H/D exceeds about 0.15, the sustain discharge voltage V_{S} is relatively low.

Accordingly, as described above, according to the present invention, it is possible to improve luminous efficiency and lower a discharge firing voltage by forming a groove in a first dielectric layer having appropriate dimensions.

It will be apparent to those skilled in the art that various modifications and variations can be made in the present invention without departing from the spirit or hope of the invention. Thus, it is intended that the present invention cover the modifications and variations of this invention provided they come within the scope of the appended claims and their equivalents.

What is claimed is:

1. A plasma display panel comprising:
a rear substrate;
a front substrate separated from the rear substrate;
barrier ribs disposed between the front substrate and the rear substrate and defining discharge cells;
sustain electrode pairs comprising an X electrode and a Y electrode and overlapping the discharge cells;
an intermediate electrode arranged between an X electrode and Y electrode of each sustain electrode pair;
a first dielectric layer comprising grooves which are formed such that each groove is located between an X electrode and a Y electrode of each sustain electrode pair and covering the sustain electrode pairs and corresponding to the intermediate electrode;
address electrodes and extending across the discharge cells and overlapping the sustain electrode pairs and the intermediate electrodes;
a second dielectric layer covering the address electrodes;
phosphor layers respectively formed in the discharge cells; and
discharge gas filling the discharge cells.

2. The plasma display panel of claim 1, wherein a relative ratio (H/D) of a depth (H) of a groove with respect to a thickness (D) of the first dielectric layer is about 0.15 to about 0.45.

3. The plasma display panel of claim 2, wherein the depth (H) of the groove is about 6 μm to about 18 μm.

4. The plasma display panel of claim 1, wherein the grooves are positioned symmetrical to the discharge cells.

5. The plasma display panel of claim 1, wherein the sustain electrode pairs and the intermediate electrodes are positioned at substantially the same height relative to the front substrate.

6. The plasma display panel of claim 5, wherein the sustain electrode pairs and the intermediate electrodes are arranged on a rear surface of the front substrate.

7. The plasma display panel of claim 1, further comprising a protective layer covering the first dielectric layer.

8. The plasma display panel of claim 1, wherein the grooves are discontinuously formed and each groove corresponds to each of the discharge cells.

9. The plasma display panel of claim 1, wherein the grooves are formed across a line of the discharge cells.

10. The plasma display panel of claim 1, wherein each of the intermediate electrodes is positioned substantially the same distance from the paired X electrode and Y electrode.

11. The plasma display panel of claim 1, wherein the grooves are formed in a portion of the first dielectric layer and positioned over each of the intermediate electrodes.

12. A discharge cell of a plasma display device, comprising:
a first dielectric layer arranged on a substrate,
wherein a surface of the first dielectric layer defines a groove in the first dielectric.

13. The discharge cell of claim 12, further comprising a first electrode and a second electrode interposed between the substrate and the first dielectric, and the groove is positioned between the first electrode and the second electrode.

14. The discharge cell of claim 13, further comprising a third electrode arranged between the first electrode and the second electrode, and the groove is positioned over the third electrode.

15. The discharge cell of claim 12, wherein the groove has a depth H and the first dielectric layer in a region next to the groove has a thickness D, and the ratio of H/D ranges between about 0.15 to about 0.45, and the depth H of the groove ranges between about 6 μm to about 18 μm.

16. An upper plate of plasma display device, comprising:
a front substrate;
a first dielectric having a first side and a second side arranged on the front substrate with the first side adjacent the front substrate,
wherein a surface of the second side of the first dielectric is non-planar and defines thinner regions and thicker regions in the first dielectric arranged in a predetermined pattern.

17. The upper plate of claim 16, further comprising electrodes interposed between the first dielectric and the front substrate, wherein the thinner regions define grooves in the first dielectric, wherein the grooves are arranged parallel to the electrodes.

18. The upper plate of claim 17, wherein the electrodes comprise first electrodes and second electrodes arranged in pairs, wherein the grooves are positioned between a first electrode and a second electrode of a corresponding electrode pair.

19. The upper plate of claim 18, wherein the grooves have a depth H and the first dielectric layer in a region next to the grooves has a thickness D, and the ratio of H/D ranges between about 0.15 to about 0.45, and the depth H of the groove ranges between about 6 μm to about 18 μm.

20. The upper plate of claim 17, wherein the grooves are discontinuous.
